(19) United States
(12) Patent Application Publication
(10) Pub. No.: US 2019/0006787 A1
(43) Pub. Date: Jan. 3, 2019

(54) SEAL MEMBER FOR VEHICLE AND ELECTRIC RELAY COMPONENT FOR VEHICLE

(71) Applicants: AutoNetworks Technologies, Ltd., Yokkaichi (JP); Sumitomo Wiring Systems, Ltd., Yokkaichi (JP); SUMITOMO ELECTRIC INDUSTRIES, LTD., Osaka (JP)

(72) Inventors: Takashi KAWAKAMI, Yokkaichi (JP); Tetsuya NAKAMURA, Yokkaichi (JP); Kazuo NAKASHIMA, Yokkaichi (JP)

(21) Appl. No.: 16/011,138

(22) Filed: Jun. 18, 2018

(30) Foreign Application Priority Data
Jun. 30, 2017 (JP) 2017-129311

(51) Int. Cl. H01R 13/52; H01R 13/50; B29C 45/14; B29C 45/16; B60R 16/02; H01R 43/24

(52) U.S. Cl. CPC H01R 13/5205; H01R 13/50; B29C 45/14639; B29C 45/1671; B29L 2031/3481; H01R 13/521; H01R 13/5216; H01R 43/24; B60R 16/0215

(57) ABSTRACT

A seal member for a vehicle that is capable of suppressing a decrease in the adhesive strength and the fluidization of the adhesive and maintaining a high sealing property even in the case where the seal member is exposed to a heat reception environment and an oil environment, and an electric relay component for a vehicle using this seal member. The seal member is constituted by a crosslinked adhesive composition containing an unvulcanized acrylic rubber having at least one functional group out of an epoxy group and a carboxy group and a vulcanizing agent capable of reacting with the functional group so as to form a crosslinking point. Preferably, the adhesive composition further contains a silane coupling agent. An electric relay component for a vehicle has a seal portion constituted by the seal member.

### CROSS REFERENCE TO RELATED APPLICATIONS

This application claims the priority of Japanese patent application JP2017-129311 filed on Jun. 30, 2017, the entire contents of which are incorporated herein.

### TECHNICAL FIELD

The present invention relates to a seal member for a vehicle and an electric relay component for a vehicle.

### BACKGROUND ART

Conventionally, in an electric relay component for a vehicle, a seal member using an adhesive has been used in order to ensure liquid resistance to liquid such as oil or water.

For example, an electric relay component for a vehicle including a terminal fitting connected to a conductor of an electric wire and a molded resin portion that covers a portion for electrical connection (electrical connection portion) between the terminal fitting and the conductor is known as the electric relay component for a vehicle. In general, the molded resin portion is unlikely to adhere to a metal terminal fitting, and its size tends to change due to mold shrinkage or the like. Thus, in order to seal a gap that is inevitably formed between the terminal fitting and the molded resin portion, a seal member is often provided in the gap portion (see JP 2009-252712A). Specifically, a chloroprene rubber-based adhesive, a hydrogenated nitrile rubber-based adhesive, and the like are known as the seal member.

### SUMMARY

However, if a heating test in which a vehicle environment is simulated is performed on a seal member made of a chloroprene rubber-based adhesive or the like, from the viewpoint of heat resistance, there is a concern that the adhesive strength will decrease or the adhesive will be fluidized due to softening accompanying deterioration caused by heat reception, causing a decrease in the sealing property. Also, if oil immersion testing in which a vehicle environment is simulated is performed on the seal member made of a chloroprene rubber-based adhesive or the like, from the viewpoint of oil resistance, there is a concern that the adhesive strength will decrease or the adhesive will be fluidized due to swelling, shrinkage, or dissolution accompanying deterioration caused by contact with oil, causing a decrease in the sealing property.

The present disclosure was made in light of the above-described circumstances, and provides a seal member for a vehicle that is capable of suppressing a decrease in the adhesive strength and fluidization of an adhesive and maintaining a high sealing property even in the case where the seal member is exposed to a heat reception environment and an oil environment, and provides an electric relay component for a vehicle using this seal member for a vehicle.

One aspect of the present disclosure is a seal member for a vehicle, constituted by a crosslinked adhesive composition containing an unvulcanized acrylic rubber having at least one functional group out of an epoxy group and a carboxy group and a vulcanizing agent capable of reacting with the functional group so as to form a crosslinking point.

Another aspect of the present disclosure is an electric relay component for a vehicle, including a seal portion constituted by the seal member for a vehicle.

The seal member for a vehicle is constituted by a crosslinked adhesive composition containing an unvulcanized acrylic rubber having at least one functional group out of an epoxy group and a carboxy group and a vulcanizing agent capable of reacting with the functional group so as to form a crosslinking point. Thus, the seal member for a vehicle can suppress deterioration and softening accompanying deterioration caused by heat reception even in the case where the seal member for a vehicle is exposed to a heat reception environment, and can suppress swelling, shrinkage, or dissolution accompanying deterioration caused by contact with oil even in the case where the seal member is exposed to an oil environment. Therefore, even in the case where the seal member for a vehicle is exposed to a heat reception environment and an oil environment, the seal member for a vehicle can suppress a decrease in the adhesive strength and the fluidization of the adhesive, and maintain a high sealing property, compared to a conventional seal member made of a chloroprene rubber-based adhesive or the like.

The electric relay component for a vehicle includes a seal portion constituted by the seal member for a vehicle. Therefore, even in the case where the electric relay component for a vehicle is exposed to a heat reception environment and an oil environment, the electric relay component for a vehicle can maintain a high liquid resistance for a long time, compared to a convention electric relay component for a vehicle having a seal portion constituted by a seal member made of a chloroprene rubber-based adhesive or the like.

### BRIEF DESCRIPTION OF THE DRAWINGS

FIG. 1 is a plan view of an electric relay component for a vehicle of Working Example 1;

FIG. 2 is a cross-sectional view of the electric relay component for a vehicle of Working Example 1 taken along line II-II;

FIG. 3 is a front view of an electric relay component for a vehicle of Working Example 2;

FIG. 4 is a plan view of an electric relay component for a vehicle of Working Example 2;

FIG. 5 is a cross-sectional view taken along V-V in FIG. 3;

FIGS. 6A-6B are illustrative diagrams for illustrating a seal portion formation position during production of a test piece for leak testing, FIG. 6A being a top view and FIGS. 6B being a side view; and

FIGS. 7A-7C are illustrative diagrams for illustrating a resin portion formation position during production of a test piece for leak testing, FIG. 7A being a top view and FIG. 7B being a side view, and FIG. 7C being a cross-sectional view taken along line VII-VII.

### EMBODIMENTS

In an adhesive composition for the seal member for a vehicle, an unvulcanized acrylic rubber has at least one functional group out of an epoxy group and a carboxy group. That is, the unvulcanized acrylic rubber may have an epoxy group, a carboxy group, or both an epoxy group and a carboxy group.

A vulcanizing agent is capable of reacting with the functional group of the unvulcanized acrylic rubber so as to form a crosslinking point. Specifically, if the unvulcanized acrylic rubber has an epoxy group as the functional group, the vulcanizing agent may be at least one of a dithiocarbamate-based vulcanizing agent and an ammonia-based vulcanizing agent. With this configuration, the formation of crosslinking caused by reaction between the vulcanizing agent and an epoxy group is ensured, and the above-described effects can be ensured. Note that both the dithiocarbamate-based vulcanizing agent and the ammonia-based vulcanizing agent may have one or more reactive groups that react with an epoxy group.

Also, if the unvulcanized acrylic rubber has a carboxy group as the functional group, the vulcanizing agent may be at least one of an amine-based vulcanizing agent and a thiourea-based vulcanizing agent. With this configuration, the formation of crosslinking caused by reaction between the vulcanizing agent and a carboxy group is ensured, and the above-described effects can be ensured. Note that both the amine-based vulcanizing agent and the thiourea-based vulcanizing agent may have one or more reactive groups that react with a carboxy group.

From the viewpoint of the formation of a crosslinking point, the content of the vulcanizing agent in the adhesive composition is preferably 0.1 parts by mass or more, more preferably 0.5 parts by mass or more, and even more preferably 1 parts by mass or more, still more preferably 1.5 parts by mass or more, and still more preferably 2 parts by mass or more, with respect to 100 parts by mass of the unvulcanized acrylic rubber. Also, from the viewpoint of ensuring an appropriate flexibility and cost reduction, the content of the vulcanizing agent in the adhesive composition is preferably 10 parts by mass or less, more preferably 7 parts by mass or less, even more preferably 5 parts by mass or less, and still more preferably 3 parts by mass or less, with respect to 100 parts by mass of the unvulcanized acrylic rubber.

In the seal member for a vehicle, the adhesive composition may further contain a silane coupling agent. According to this configuration, it is possible to easily suppress a decrease in the adhesive strength and the fluidization of the adhesive caused by the above-described heat reception and contact with oil, and to continuously ensure a high adhesive strength even in the case where the seal member for a vehicle is repeatedly exposed to a heat reception environment and an oil environment for a long period of time. Therefore, according to this configuration, it is possible to obtain a seal member for a vehicle whose high sealing property is easily maintained for a long time. Also, this configuration is advantageous for increasing the sealing property due to an increase in the adhesiveness. It is conceivable that the adhesiveness increases due to use in combination with a silane coupling agent because when a seal member for a vehicle is used in contact with a metal material, hydrogen bonds are formed between functional groups in the silane coupling agent and hydroxy groups present on the surface of the metal material.

From the viewpoint of an increase in the adhesive strength and the like, the content of the silane coupling agent in the adhesive composition is preferably 0.5 parts by mass or more, more preferably 1 part by mass or more, even more preferably 1.5 parts by mass or more, and still more preferably 2 parts by mass or more, with respect to 100 parts by mass of the unvulcanized acrylic rubber. Also, from the viewpoint of cost reduction, the content of the silane coupling agent in the adhesive composition is preferably 10 parts by mass or less, more preferably 7 parts by mass or less, and even more preferably 5 parts by mass or less, with respect to 100 parts by mass of the unvulcanized acrylic rubber.

In the seal member for a vehicle, the adhesive composition may contain one or more additive agents such as a peptizing agent, an age resister, a vulcanization accelerator, a pigment, and a filler.

The seal member for a vehicle may have a configuration in which no air leakage occurs in leak testing performed at an air pressure of 150 kPa for 60 seconds after heat treatment is performed at 150° C. for 1000 hours. Also, the seal member for a vehicle may have a configuration in which no air leakage occurs in leak testing performed at an air pressure of 150 kPa for 60 seconds after heat cycle treatment in which a heat cycle is repeated 750 times, the heat cycle being such that a temperature is kept at −40° C. for 2 hours and then kept at 150° C. for 2 hours. According to these configurations, it is possible to ensure the above-described effects and to obtain a seal member for a vehicle that is particularly suitable for use in a heat reception environment and/or an oil environment in a vehicle. If the seal member for a vehicle has both of the above-described configurations, the above-described effects can be further ensured. Note that the above-described leak testing after heat treatment and leak testing after heat cycles are performed using test pieces produced using the above-described adhesive composition. Details will be described in experiment examples.

The seal member for a vehicle may have a configuration in which a weight increase percentage after the seal member for a vehicle is immersed in an ATF oil at 150° C. for 1000 hours is 0.15% or less. According to this configuration, it is possible to easily suppress a decrease in the adhesive strength and the fluidization of the adhesive caused by the above-described heat reception and contact with oil, and to continuously ensure a high adhesive strength even in the case where the seal member is repeatedly exposed to a heat reception environment and an oil environment. Therefore, according to this configuration, it is possible to obtain a seal member for a vehicle whose high sealing property is easily maintained for a long time.

From the viewpoint of ensuring the above-described effects or the like, the above-described weight increase percentage may be preferably 0.14% or less, more preferably 0.13% or less, and more preferably 0.12% or less. Note that the weight increase is caused by deterioration caused by contact with oil, and thus it is preferable that the weight hardly increases. Therefore, there is no particular limitation on the lower limit of the weight increase percentage. Note that the above-described weight increase percentage is measured using test pieces produced using the above-described adhesive composition. Details will be described in experiment examples.

The seal member for a vehicle may have a configuration in which an initial tensile shear adhesive strength is 1500 kPa or more. According to this configuration, the seal member has a high adhesive strength in a stage prior to exposure to a heat reception environment, and thus can exhibit a high sealing property. Also, even in the case where the seal member for a vehicle is exposed to a heat reception environment, it is possible to suppress a decrease in the adhesive strength and the fluidization of the adhesive. Thus, according to the above-described configuration, it is possible to obtain a seal member that can easily ensure a high adhesive strength even in the case where the seal member is exposed to a heat reception environment.

From the viewpoint of exhibiting a high sealing property, the initial tensile shear adhesive strength is preferably 1520 kPa or more, more preferably 1600 kPa or more, even more preferably 1650 kPa or more, still more preferably 1700 kPa or more, still more preferably 1750 kPa or more, and particularly preferably 1800 kPa or more. Note that from the viewpoint of obtaining a high sealing property, there is no particular limitation on the upper limit of the initial tensile shear adhesive strength. Note that the above-described initial tensile shear adhesive strength refers to a tensile shear adhesive strength in an initial stage before heat treatment. Also, the initial tensile shear adhesive strength is measured using test pieces produced using the above-described adhesive composition. Details will be described in experiment examples.

The seal member for a vehicle may have a configuration having a first surface that is in contact with Sn or a Sn alloy, and a second surface that is in contact with resin.

Sn ions produced from Sn or the Sn alloy function as catalysts, and promote deterioration of the seal member constituted by a rubber-based adhesive at the time of heat reception in some cases. In particular, a widely used conventional chloroprene rubber-based adhesive reacts with Sn ions and produces chlorides at the time of heat reception in some cases. The produced chlorides accelerate deterioration of the seal member. Thus, with the seal member constituted by a chloroprene rubber-based adhesive, there is a limit to suppression of a decrease in the adhesive strength and the fluidization of the adhesive caused by softening accompanying deterioration caused by heat reception. In contrast, the seal member for a vehicle has resistance to deterioration caused by catalysis of the Sn ions. Thus, according to the above-described configuration, it is possible to suppress a decrease in the adhesive strength and fluidization of the adhesive and to maintain a high sealing property even in the case where the seal member for a vehicle is exposed to a heat reception environment in a state in which the seal member for a vehicle is interposed between the resin and Sn or the Sn alloy. Note that an example of Sn or the Sn alloy is a Sn-based plating layer formed on a surface of a terminal fitting or a bus bar. Also, an example of the resin is a resin that constitutes a molded resin portion.

For example, the seal member for a vehicle can be suitably used in a seal portion of an electric relay component for a vehicle. According to this configuration, it is possible to realize an electric relay component for a vehicle that is capable of maintaining a high liquid resistance for a long time even in the case where the seal member for a vehicle is exposed to a heat reception environment and an oil environment. An example of the electric relay component for a vehicle is an electric relay component for a vehicle having a terminal fitting connected to a conductor of an electric wire, a molded resin portion that covers a portion for electrical connection between the terminal fitting and the conductor, and a seal portion that seals a gap between the terminal fitting and the molded resin portion. Also, another example of the electric relay component for a vehicle is a terminal board for a vehicle including a bus bar, a housing having a molded resin portion for fixing the bus bar, and a seal portion that seals a gap between the bus bar and the molded resin portion.

The above-described configurations can be arbitrarily combined as needed to obtain the above-described effects or the like.

### WORKING EXAMPLES

Hereinafter, a seal member for a vehicle and an electric relay component for a vehicle of working examples will be described with reference to the drawings. Note that an example will be described using an example in which a seal member for a vehicle is applied to the seal portion of the electric relay component for a vehicle.

### Working Example 1

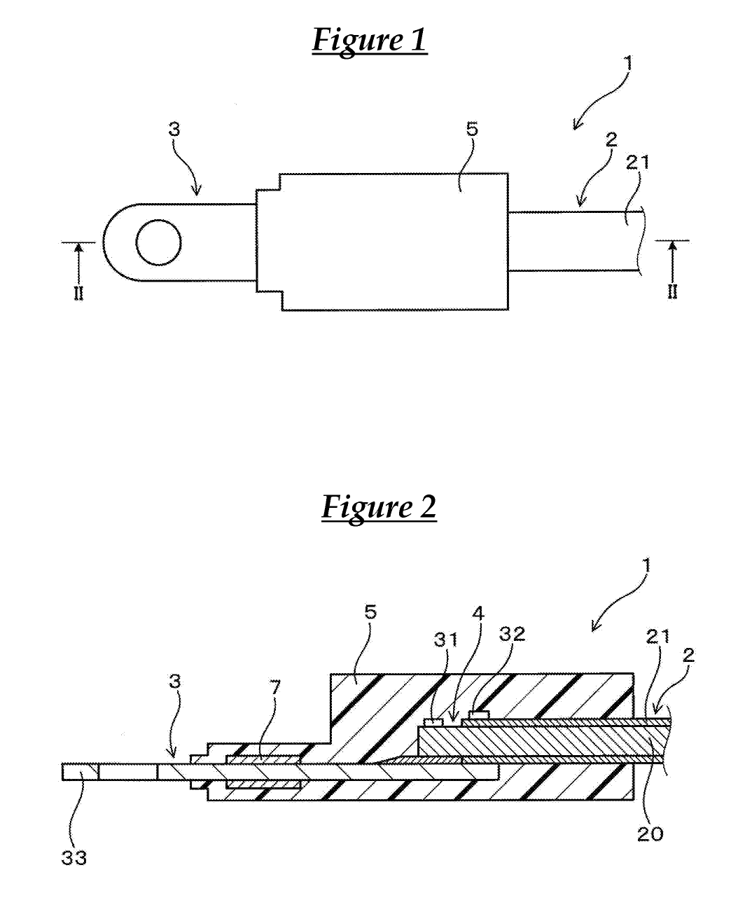

As shown in FIGS. 1 and 2, an electric relay component 1 for a vehicle in this working example includes a terminal fitting 3 connected to a conductor 20 of an electric wire 2, a molded resin portion 5 that covers at least a portion 4 for electrical connection between the terminal fitting 3 and the conductor 20, and a seal portion 7 that seals a gap formed between the terminal fitting 3 and the molded resin portion 5. In this working example, the terminal fitting 3 has a conductor crimping portion 31 that crimps the conductor 20 of the electric wire 2 and an insulator crimping portion 32 that crimps an insulator 21 of the electric wire 2. Also, in this working example, a connection portion 33 of the terminal fitting 3 to be connected to a partner terminal fitting (not shown) protrudes from the molded resin portion 5, and the terminal fitting 3 that is closer to the electric wire 4 side than the connection portion 33 is embedded in the molded resin portion 5. The seal portion 7 seals the gap formed between the terminal fitting 3 and the molded resin portion 5 between the connection portion 33 and the electrical connection portion 4.

In this working example, specifically, the molded resin portion 5 is made of a thermoplastic resin. Also, specifically, the terminal fitting 3 includes a base material constituted by Cu or a Cu alloy, and a Sn-based plating layer that is constituted by Sn or a Sn alloy and covers a surface of the base material.

The seal portion 7 is formed by a seal member for a vehicle constituted by a crosslinked adhesive composition containing an unvulcanized acrylic rubber having at least one functional group out of an epoxy group and a carboxy group and a vulcanizing agent capable of reacting with the functional group so as to form a crosslinking point. The seal portion 7 has a first surface that is in contact with the Sn-based plating layer of the terminal fitting 3 and a second surface that is in contact with resin that constitutes the molded resin portion 5.

The seal portion 7 is constituted by a crosslinked adhesive composition containing an unvulcanized acrylic rubber having at least one functional group out of an epoxy group and a carboxy group and a vulcanizing agent capable of reacting with the functional group so as to form a crosslinking point. Thus, the seal portion 7 can suppress softening accompanying deterioration caused by heat reception even in the case where the seal portion 7 is exposed to a heat reception environment, and can suppress swelling, shrinkage, or dissolution accompanying deterioration caused by contact with oil even in the case where the seal portion 7 is exposed to an oil environment. Therefore, even in the case where the seal portion 7 is exposed to a heat reception environment and an oil environment, the seal portion 7 can suppress a decrease in the adhesive strength and the fluidization of the adhesive, and can maintain a high sealing property, compared to a conventional seal portion made of a chloroprene rubber-based adhesive or the like.

Also, the electric relay component 1 for a vehicle has the seal portion 7. Thus, even in the case where the electric relay component 1 for a vehicle is exposed to a heat reception environment and an oil environment, the electric relay component 1 for a vehicle in this working example can maintain a high liquid resistance for a long time, compared to a conventional electric relay component for a vehicle having a seal portion made of a chloroprene rubber-based adhesive or the like.

### Working Example 2

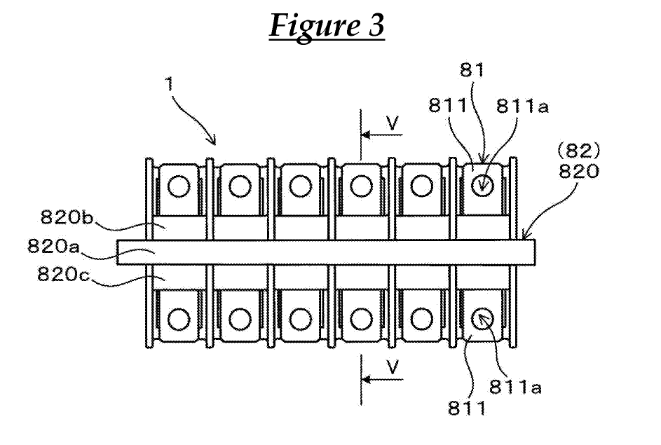

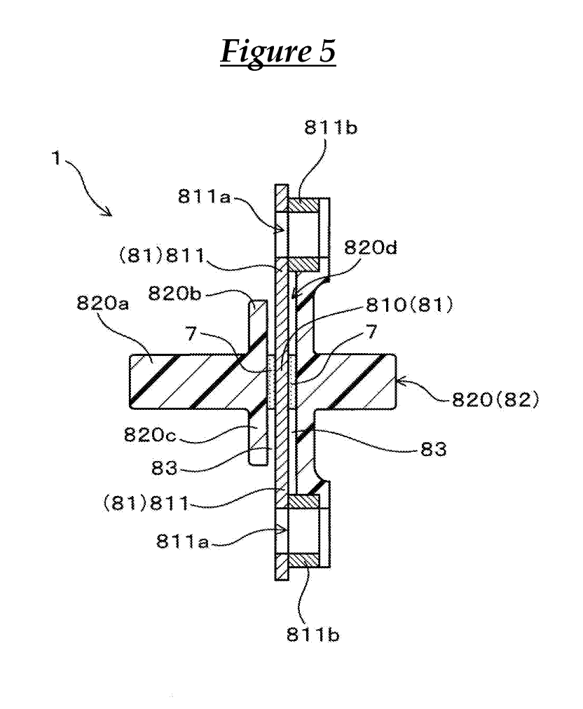

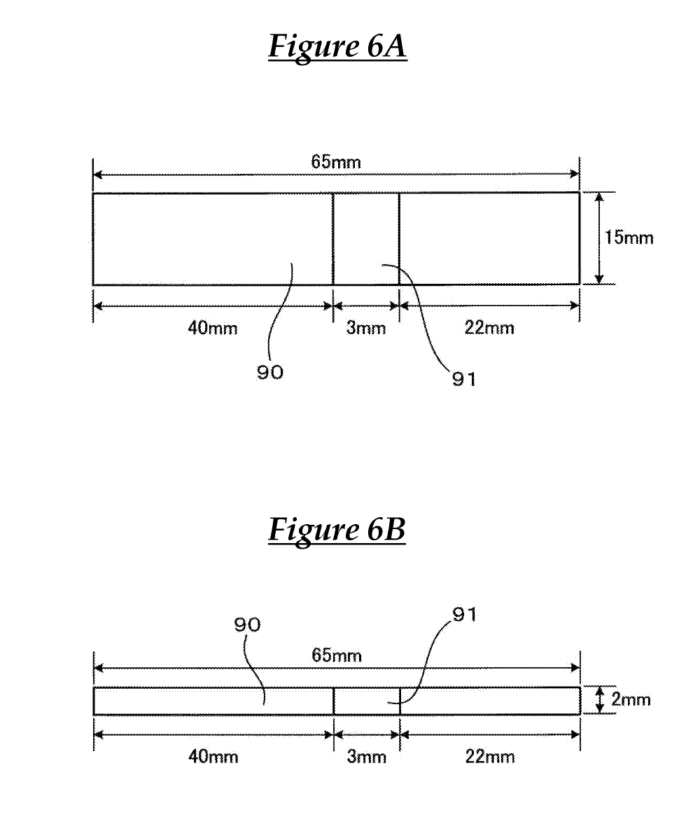

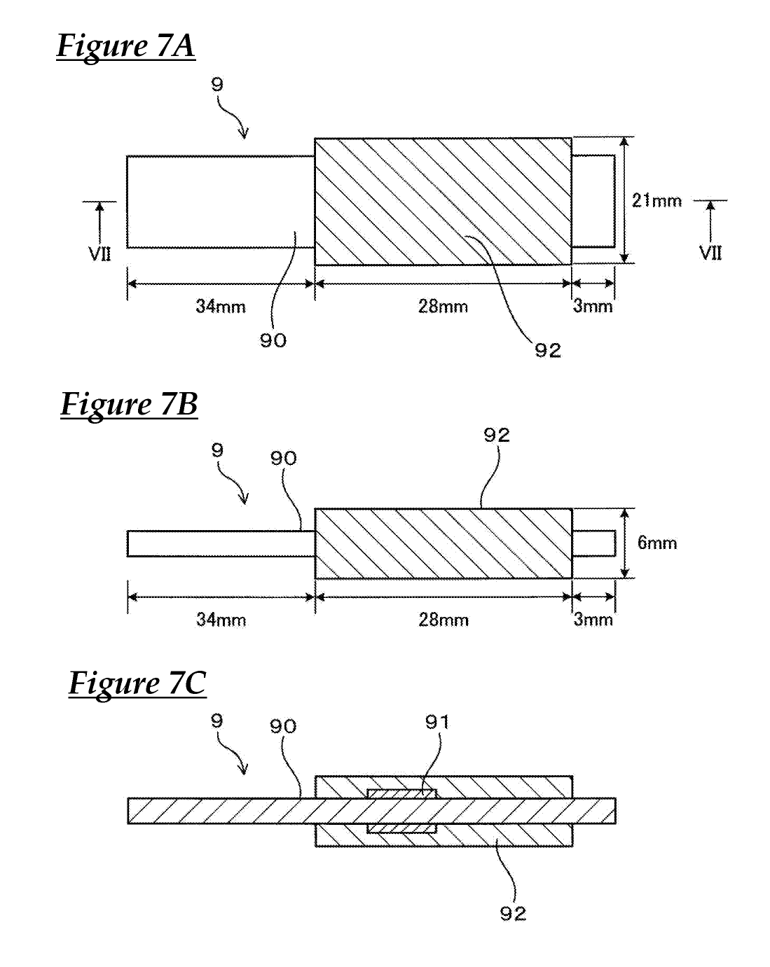

As shown in FIGS. 3 to 5, an electric relay component 1 for a vehicle in this working example includes bus bars 81, a housing 82 having a molded resin portion 820 that fixes the bus bars 81, and seal portions 7 that seal gaps 83 between the bus bars 81 and the molded resin portion 820. Specifically, in the electric relay component 1 for a vehicle of this working example, the bus bars 81 integrally include embedded portions 810 embedded in the molded resin portion 820, and connection portions 811 protruding outward from the molded resin portion 820. The seal portions 7 seal the gaps 83 present between the embedded portions 810 and the molded resin portion 820.

In this working example, the molded resin portion 820 in the housing 82 is made of a thermoplastic resin. Specifically, the thermoplastic resin is an aromatic polyamide resin (aromatic nylon resin) reinforced by glass fibers. Specifically, the molded resin portion 820 has a plate-shaped base portion 820a, a plurality of first protruding portions 820b protruding outward from a surface of the base portion 820a on the first connection side, a plurality of second protruding portions 820c protruding outward from positions of the base portion 820a on the second connection side that correspond with the first protruding portions 820b, and a plurality of bus bar holding holes 820d that pass through the base portion 820a, the first protruding portions 820b, and the second protruding portions 820c.

In this working example, specifically, the bus bars 81 have a plate shape. The bus bars 81 each include a base material constituted by Cu or a Cu alloy, and a Sn-based plating layer that is constituted by Sn or a Sn alloy and covers a surface of the base material. Note that detailed configurations of the bus bars are omitted in the drawings. The bus bars 81 are fixed to the molded resin portion 820 through insert molding. Specifically, the bus bars 81 are fixed to the molded resin portion 820 in the state in which the bus bars 81 pass through the bus bar holding holes 820d in the molded resin portion 820. Portions of the bus bars 81 that are disposed inside the bus bar holding holes 820d are the embedded portions 810. On the other hand, portions of the bus bars 81 that are exposed to the outside at the bus bar holding holes 820d are the connection portions 811. Thus, in this working example, the bus bars 81 have the connection portions 811 on both ends of the embedded portions 810. The connection portions 811 have fastening holes 811a and fastening nuts 811b for fastening a wire harness or the like. Note that an example in which a plurality (specifically, six) of the bus bars 81 are disposed in a separated state is shown in the drawings.

The seal portion 7 is formed by a seal member for a vehicle constituted by a crosslinked adhesive composition containing an unvulcanized acrylic rubber having at least one functional group out of an epoxy group and a carboxy group and a vulcanizing agent capable of reacting with the functional group so as to form a crosslinking point. The seal portion 7 has a surface that is in contact with the Sn-based plating layer of the terminal fitting 3, and a surface that is in contact with the molded resin portion 820.

The seal portion 7 has a configuration similar to that of Working Example 1, and thus this working example exhibits effects similar to those of Working Example 1.

### EXPERIMENTAL EXAMPLES

Hereinafter, specific description will be given using experimental examples.

### Production of Adhesive Composition

The following was prepared as the materials of the adhesive composition.
Unvulcanized acrylic rubber having an epoxy group (“NOXTITE PA-312” manufactured by Unimatec Corporation)
Unvulcanized acrylic rubber having a carboxy group (“NOXTITE PA-524” manufactured by Unimatec Corporation)
Unvulcanized chloroprene rubber (“SHOPRENE WRT” manufactured by Showa Denko K. K.)
Unvulcanized hydrogenated nitrile rubber (“Zetpol3110” manufactured by Zeon Corporation)
Dithiocarbamate-based vulcanizing agent (1) (“Nocceler PZ” manufactured by OUCHI SHINKO CHEMICAL INDUSTRIAL CO., LTD.)
Dithiocarbamate-based vulcanizing agent (2) (“Nocceler TTFE” manufactured by OUCHI SHINKO CHEMICAL INDUSTRIAL CO., LTD.)
Ammonia-based vulcanizing agent (“Vulnoc AB” manufactured by OUCHI SHINKO CHEMICAL INDUSTRIAL CO., LTD.)
Amine-based vulcanizing agent (“CHEMINOX AC-6” manufactured by Unimatec Corporation).
Thiourea-based vulcanizing agent (1) (“Nocceler DT” manufactured by OUCHI SHINKO CHEMICAL INDUSTRIAL CO., LTD.)
Thiourea-based vulcanizing agent (2) (“Nocceler EUR” manufactured by OUCHI SHINKO CHEMICAL INDUSTRIAL CO., LTD.)
Peroxide-based vulcanizing agent (“PERBUTYL P40” manufactured by NOF CORPORATION)
Silane coupling agent (“KBM-603” manufactured by Shin-Etsu Chemical Co., Ltd.)
Peptizing agent (stearic acid) (“LUNAC S-70V” manufactured by Kao Corporation)
Age resister (1) (“NAUGARD 445” manufactured by SHIRAISHI CALCIUM KAISHA, LTD.)
Age resister (2) (“NOCRAC TD” manufactured by OUCHI SHINKO CHEMICAL INDUSTRIAL CO., LTD.)
Solvent (toluene) (manufactured by Wako Pure Chemical Industries, Ltd.)

The adhesive compositions were obtained by mixing the materials so as to have predetermined blending ratios shown in Table 1, which will be described later. Specifically, rubber components were masticated using a kneader for 20 minutes, and then a peptizing agent was introduced and the mixture was kneaded for 15 minutes. Next, an age resister was introduced therein and the mixture was kneaded for 15 minutes. Next, a vulcanizing agent was introduced therein and the mixture was kneaded for 30 minutes. An adhesive composition was obtained by adding solvent to the obtained mixture and stirring the mixture for 6 hours. Note that when a silane coupling agent was used, an adhesive composition containing a silane coupling agent was obtained by adding the silane coupling agent to the above-described adhesive composition and stirring the mixture for 1 hour.

### Weight Increase Percentage After ATF Oil Immersion

A test piece constituted by a crosslinked adhesive composition was produced by vulcanizing the adhesive composition at 160° C. for 240 minutes. The test piece had a cube shape having a length of 20 mm, a width of 20 mm, and a height of 20 mm. After the initial mass of the prepared test piece was measured, the test piece was immersed in an ATF oil (“Apolloil ATF D2” manufactured by Idemitsu Kosan Co., Ltd.) at 150° C. for 1000 hours. Next, the weight of the immersed test piece was measured to calculate a weight increase percentage. Note that the weight increase percentage was calculated by 100× (weight of test piece after ATF oil immersion—weight of test piece before ATF oil immersion)/(weight of test piece before ATF oil immersion). Similarly to the above, the weight increase percentage was calculated in the case where the test piece was immersed in an ATF oil at 150° C. for 1500 hours.

### Tensile Shear Adhesive Strength

The adhesive composition was evenly applied to the surface of an end portion of a copper plate that was plated with Sn so as to have a thickness of 500 μm, and then the adhesive composition was naturally dried. Next, a crosslinked adhesive composition was formed by vulcanizing the adhesive composition on the copper plate that was plated with Sn at 160° C. for 240 minutes. Next, a resin plate was formed through insert molding such that the end portion is placed on the crosslinked composition formation portion. Note that an aromatic nylon resin that was reinforced with glass fibers was used as the resin for forming the resin plate. Also, the above-described insert molding conditions were such that the mold temperature was 150° C. and the cylinder temperature was 310° C. Accordingly, a test piece having a shape defined in JIS K 6850 was produced. Note that in that test piece, the copper plate that was plated with Sn and the resin plate overlapped with each other, and that overlapping portion was provided with a seal member made of the crosslinked adhesive composition. Next, heat treatment was performed on the obtained test pieces at 150° C. for 1500 hours, 150° C. for 2000 hours, and 150° C. for 2500 hours. Next, the tensile shear adhesive strength of the adhesive layer was measured by performing tensile testing in conformity with JIS K 6850 using test pieces before the heat treatment and test pieces after the heat treatment under the condition that the temperature was 23° C. and the tensile speed was 100 mm/min.

### Leak Testing After Heat Treatment

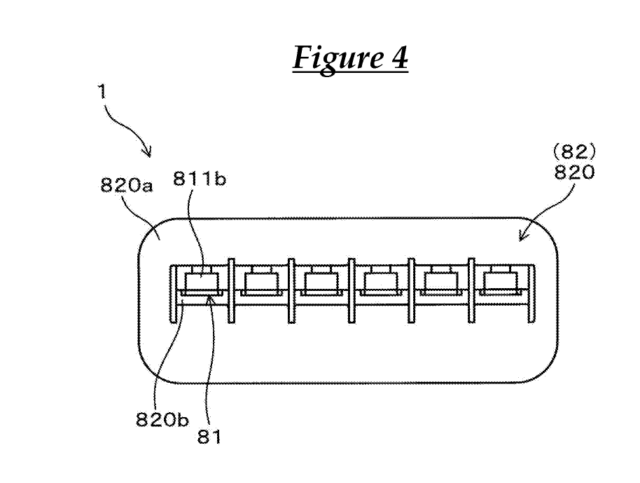

As shown in FIG. 3, the adhesive composition was evenly applied to the copper plate 90 that was plated with Sn having a length of 15 mm, a width of 65 mm, and a thickness of 2 mm in an intermediate portion in the longitudinal direction of the copper plate 90, so as to circle the copper plate 90 once, the adhesive composition having a thickness of 500 μm, and then the adhesive composition was naturally dried. Next, the crosslinked adhesive composition was formed by vulcanizing the adhesive composition on the copper plate 90 that was plated with Sn at 160° C. for 240 minutes. Note that reference numeral 91 indicates a seal portion constituted by the crosslinked adhesive composition, and the width of the seal portion 91 was 3 mm. Next, as shown in FIG. 4, a molded resin portion 92 was formed through insert molding so as to cover the seal portion 91. Note that an aromatic nylon resin that was reinforced with glass fibers was used as the resin for forming the molded resin portion 92. Also, the above-described insert molding conditions were such that the mold temperature was 150° C. and the cylinder temperature was 310° C. Note that in the produced test piece 9, both end portions of the copper plate 90 that was plated with Sn protruded from the molded resin portion 92. Next, heat treatment was performed on the obtained test pieces 9 at 150° C. for 1500 hours, 150° C. for 2000 hours, and 150° C. for 2500 hours. Next, leak testing was performed using the heat treated test pieces 9. Specifically, the left side in FIG. 4, that is, an end portion of the test piece 9 having a large amount of protrusion from the molded resin portion 92 on the copper plate 90 that was plated with Sn was inserted into a hose (not shown), and one end portion of the hose was disposed on the outer periphery of the molded resin portion 92. Next, the outer periphery at one end portion of the hose was sealed with moisture curable silicone, preventing air leakage from a gap between the hose and the outermost surface of the molded resin portion 92. Next, compressed air having a pressure of 150 kPa was introduced from the other end portion of the hose, and it was checked whether or not air leaked from a gap between the copper plate 90 that was plated with Sn and the molded resin portion 92.

### Leak Testing After Heat Cycle Treatment

In leak testing after the above-described heat treatment, heat cycle treatment in which a heat cycle was repeated 750 times was performed on the obtained test piece instead of the above-described heat treatment, the heat cycle being such that the temperature was kept at −40° C. for 2 hours and then kept at 150° C. for 2 hours. Similarly, heat cycle treatment in which the above-described heat cycle was repeated 1000 times or 1250 times was also performed. It was checked whether or not air leaked from a gap between the copper plate 90 that was plated with Sn and the molded resin portion 92 similarly to leak testing after the above-described heat treatment, except for those points.

Table 1 shows specific blending of the adhesive compositions that were used to produce seal members of Samples 1 to 5, and Samples 1C and 2C. Also, Table 2 collectively shows various test results of the seal members of Samples 1 to 5, and Samples 1C and 2C. Note that compared to the seal members of the other samples, the seal member of Sample 2C had a significantly larger weight increase percentage after ATF oil immersion, and thus the other tests were omitted.

TABLE 1

| | | | Test Pieces | | | | | | |
|---|---|---|---|---|---|---|---|---|---|
| | | | 1 | 2 | 3 | 4 | 5 | 1C | 2C |
| Seal | adhesive | unvulcanized acrylic rubber | 100 | 100 | 100 | 100 | — | — | — |
| member | composition | having epoxy group | | | | | | | |
| | (parts by | unvulcanized acrylic rubber | — | — | — | — | 100 | — | — |
| | mass) | having carboxy group | | | | | | | |
| | | unvulcanized chloroprene | — | — | — | — | — | 100 | — |
| | | rubber | | | | | | | |
| | | unvulcanized hydrogenated | — | — | — | — | — | — | 100 |
| | | nitrile rubber | | | | | | | |
| | | vulcanizing agent | | | | | | | |
| | | dithiocarbamate-based | 2.5 | — | 2.5 | — | — | — | — |
| | | vulcanizing agent (1) | | | | | | | |
| | | dithiocarbamate-based | 1 | — | 1 | — | — | — | — |
| | | vulcanizing agent (2) | | | | | | | |
| | | ammonia-based | — | 2.5 | — | 2.5 | — | — | — |
| | | vulcanizing agent | | | | | | | |
| | | amine-based | — | — | — | — | 1 | — | — |
| | | vulcanizing agent | | | | | | | |
| | | thiourea-based | — | — | — | — | 2.5 | — | — |
| | | vulcanizing agent (1) | | | | | | | |
| | | thiourea-based | — | — | — | — | — | 2 | — |
| | | vulcanizing agent (2) | | | | | | | |
| | | peroxide-based | — | — | — | — | — | — | 8 |
| | | vulcanizing agent | | | | | | | |
| | | silane coupling agent | — | — | 4 | 4 | 4 | — | — |
| | | peptizing agent | 1 | 1 | 1 | 1 | 1 | 2 | 1 |
| | | age resister (1) | 2 | 2 | 2 | 2 | 2 | — | 2 |
| | | age resister (2) | — | — | — | — | — | 1.5 | — |
| | | solvent: toluene | 210 | 210 | 210 | 210 | 210 | 210 | 210 |

TABLE 2

| | | Test Pieces | | | | | | |
|---|---|---|---|---|---|---|---|---|
| | | 1 | 2 | 3 | 4 | 5 | 1C | 2C |
| Weight increase | ATF temp. × time | | | | | | | |
| percentage (%) after | of immersion in ATF | | | | | | | |
| ATF oil immersion | 150° C. × 1000 h | 0.11 | 0.10 | 0.12 | 0.11 | 0.10 | 0.16 | 2.40 |
| | 150° C. × 1500 h | 0.13 | 0.11 | 0.15 | 0.16 | 0.12 | 0.18 | 3.64 |
| Tensile shear | before heat | 1540 | 1529 | 1899 | 1884 | 1523 | 1424 | — |
| adhesive strength | treatment (initial) | | | | | | | |
| (kPa) | after heat treatment | | | | | | | |
| | 150° C. × 1500 h | 1168 | 1159 | 1647 | 1638 | 1226 | 264 | — |
| | 150° C. × 2000 h | 349 | 314 | 1445 | 1439 | 1185 | 215 | — |
| | 150° C. × 2500 h | 286 | 229 | 1237 | 1222 | 1008 | 106 | — |
| Leak testing | after heat treatment | | | | | | | |
| (air pressure was | 150° C. × 1500 h | no leakage | no leakage | no leakage | no leakage | no leakage | leakage | — |
| 150 kPa × 60 sec) | | occurred | occurred | occurred | occurred | occurred | occurred | |
| | 150° C. × 2000 h | leakage | leakage | no leakage | no leakage | no leakage | leakage | — |
| | | occurred | occurred | occurred | occurred | occurred | occurred | |
| | 150° C. × 2500 h | leakage | leakage | no leakage | no leakage | no leakage | leakage | — |
| | | occurred | occurred | occurred | occurred | occurred | occurred | |
| | after heat cycle treatment | | | | | | | |
| | −40° C.↔150° C. | no leakage | no leakage | no leakage | no leakage | no leakage | leakage | — |
| | (2 h each), | occurred | occurred | occurred | occurred | occurred | occurred | |
| | 4 h/cycle, 750 cycles | | | | | | | |
| | −40° C.↔150° C. | leakage | leakage | no leakage | no leakage | no leakage | leakage | — |
| | (2 h each), | occurred | occurred | occurred | occurred | occurred | occurred | |
| | 4 h/cycle, 1000 cycles | | | | | | | |
| | −40° C.↔150° C. | leakage | leakage | no leakage | no leakage | no leakage | leakage | — |
| | (2 h each), | occurred | occurred | occurred | occurred | occurred | occurred | |
| | 4 h/cycle, 1250 cycles | | | | | | | |

In the seal member of Sample 1C, a rubber component that was used in the adhesive composition was an unvulcanized chloroprene rubber and was not an unvulcanized acrylic rubber having at least one functional group out of an epoxy group and a carboxy group. Thus, when the seal member of Sample 1C was exposed to a heat reception environment and an oil environment, the seal member of Sample 1C did not suppress a decrease in the adhesive strength and the fluidization of the adhesive, and did not maintain a high sealing property.

In contrast, the seal members of Samples 1 to 5 were constituted by crosslinked adhesive compositions containing an unvulcanized acrylic rubber having at least one function group out of an epoxy group and a carboxy group, and a vulcanizing agent capable of reacting with the functional group so as to form a crosslinking point. Thus, it was confirmed that even in the case where the seal members of Samples 1 to 5 were exposed to a heat reception environment and an oil environment, they suppressed a decrease in the adhesive strength and the fluidization of the adhesive, and maintained a high sealing property.

Also, the following was found by comparing the seal members of Samples 3 to 5 with the seal members of Samples 1 and 2. That is, it was confirmed that when the adhesive composition contained a silane coupling agent, the seal members continuously ensured a high adhesive strength even in the case where they were repeatedly exposed to a heat reception environment and an oil environment for a long period of time.

Although working examples of the present disclosure have been described in detail above, the present invention is not limited to the above-described working examples and experimental examples, and various modifications can be made without departing from the gist of the present invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

1 Electric relay component for vehicle

7 Seal member for vehicle (seal portion)

What is claimed is:

1. A seal member for a vehicle, constituted by a crosslinked adhesive composition comprising:
an unvulcanized acrylic rubber having at least one functional group out of an epoxy group and a carboxy group; and
a vulcanizing agent capable of reacting with the functional group so as to form a crosslinking point.

2. The seal member for a vehicle according to claim 1,
wherein the functional group is the epoxy group, and
the vulcanizing agent is at least one of a dithiocarbamate-based vulcanizing agent and an ammonia-based vulcanizing agent.

3. The seal member for a vehicle according to claim 1,
wherein the functional group is the carboxy group, and
the vulcanizing agent is at least one of an amine-based vulcanizing agent and a thiourea-based vulcanizing agent.

4. The seal member for a vehicle according to claim 1,
wherein the seal member for a vehicle does not leak air in leak testing performed at an air pressure of 150 kPa for 60 seconds after heat treatment is performed at 150° C. for 1000 hours.

5. The seal member for a vehicle according to claim 1,
wherein the seal member for a vehicle does not leak air in leak testing performed at an air pressure of 150 kPa for 60 seconds after heat cycle treatment in which a heat cycle is repeated 750 times, the heat cycle being such that a temperature is kept at −40° C. for 2 hours and then kept at 150° C. for 2 hours.

6. The seal member for a vehicle according to claim 1,
wherein the adhesive composition further contains a silane coupling agent.

7. The seal member for a vehicle according to claim 1, which has a first surface that is in contact with Sn or a Sn alloy, and a second surface that is in contact with resin.

8. The seal member for a vehicle according to claim 1, which is to be used in a seal portion of an electric relay component for a vehicle.

9. An electric relay component for a vehicle, comprising
a seal portion constituted by the seal member for a vehicle according to claim 1.
